(19) United States
(12) Patent Application Publication
(10) Pub. No.: US 2017/0128871 A1
(43) Pub. Date: May 11, 2017

(54) AIR FILTER FOR ELECTRONIC DEVICES

(71) Applicant: Kelly Joseph Schumacher, Effingham, IL (US)

(72) Inventor: Kelly Joseph Schumacher, Effingham, IL (US)

(21) Appl. No.: 15/347,254

(22) Filed: Nov. 9, 2016

Related U.S. Application Data
(60) Provisional application No. 62/253,227, filed on Nov. 10, 2015.

(51) Int. Cl. B01D 46/00; B01D 46/10

(52) U.S. Cl. CPC B01D 46/0038; B01D 46/001; B01D 46/0005; B01D 46/10; B01D 2279/45

(57) ABSTRACT

An air filter system adapted to prevent pet hair, dander and other pet particulate from damaging electronic devices is provided. The air filter system may include filter frames adapted to circumscribe the vents of the electronic devices. The filter frames may include a magnetic layer to removably attaching the filter frames to the electronic devices.

### CROSS-REFERENCE TO RELATED APPLICATION

This application claims the benefit of priority of U.S. provisional application No. 62/253,227, filed 10 Nov. 2015, the contents of which are herein incorporated by reference.

### BACKGROUND OF THE INVENTION

The present invention relates to filtering systems and, more particularly, to an air filter system adapted to prevent pet hair, dander and other pet particulate from damaging electronic devices.

Pet hair and dander tends to be relatively small and so lingers in the air. As a result, electronic devices exposed to an environment containing substantial amounts of animal hair and dander can be disabled or damaged. For example, veterinarian's computers tend to fill up with pet hair, causing the computer to run slower and decreasing the computer's half-life.

As can be seen, there is a need for an air filter system adapted to prevent pet hair, dander and other pet particulate from damaging electronic devices.

### SUMMARY OF THE INVENTION

In one aspect of the present invention, an air-filter system for preventing pet particulate from damaging electronic devices includes at least one sheet of filter medium; a plurality of pairs of frame portions, wherein each pair of the plurality of pairs of frame portions sandwiches a periphery of each sheet of filter medium; and a magnetic layer attached along one of each pair of frame portions.

In another aspect of the present invention, the air-filter system for preventing pet particulate from damaging electronic devices includes at least one sheet of filter medium, wherein each filter medium having Photo Catalytic Oxidation; and randomly arranged fibers adapted for the interception of pet particulate; a plurality of pairs of frame portions, wherein each pair of the plurality of pairs of frame portions sandwiches a periphery of each sheet of filter medium, wherein each pair of frame portions is pliable material so as to conform to said periphery; and a magnetic layer attached along one of each pair of frame portions, wherein the magnetic layer is coextensive with said one of each pair of frame portions.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention, shown in use;

FIG. 2 is a perspective view of an exemplary embodiment of the present invention;

FIG. 3 is an exploded view of an exemplary embodiment of the present invention; and

FIG. 4 is a section detail view of an exemplary embodiment of the present invention, taken along line 4-4 of FIG. 1;

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides an air filter system adapted to prevent pet hair, dander and other pet particulate from damaging electronic devices. The air filter system may include filter frames adapted to circumscribe the vents of the electronic devices. The filter frames may include a magnetic layer to removably attaching the filter frames to the electronic devices.

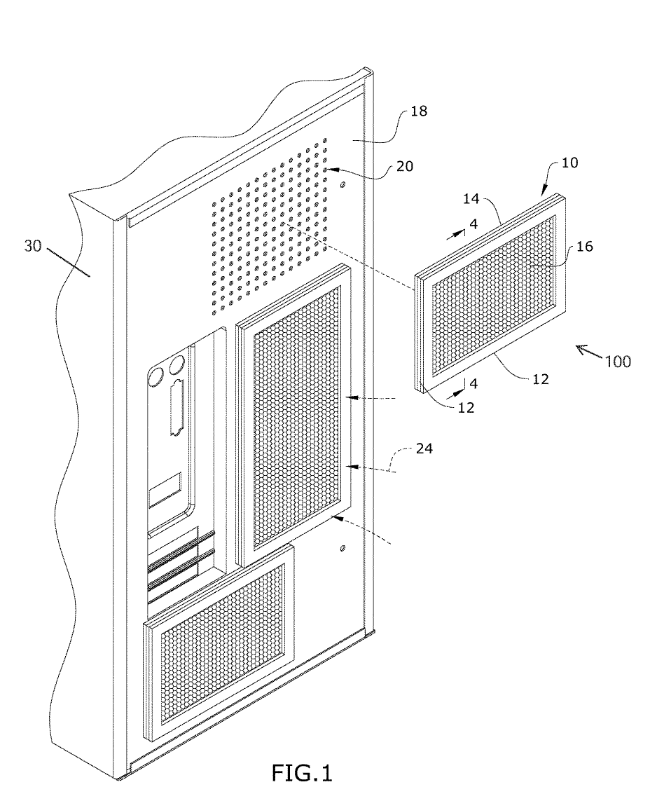

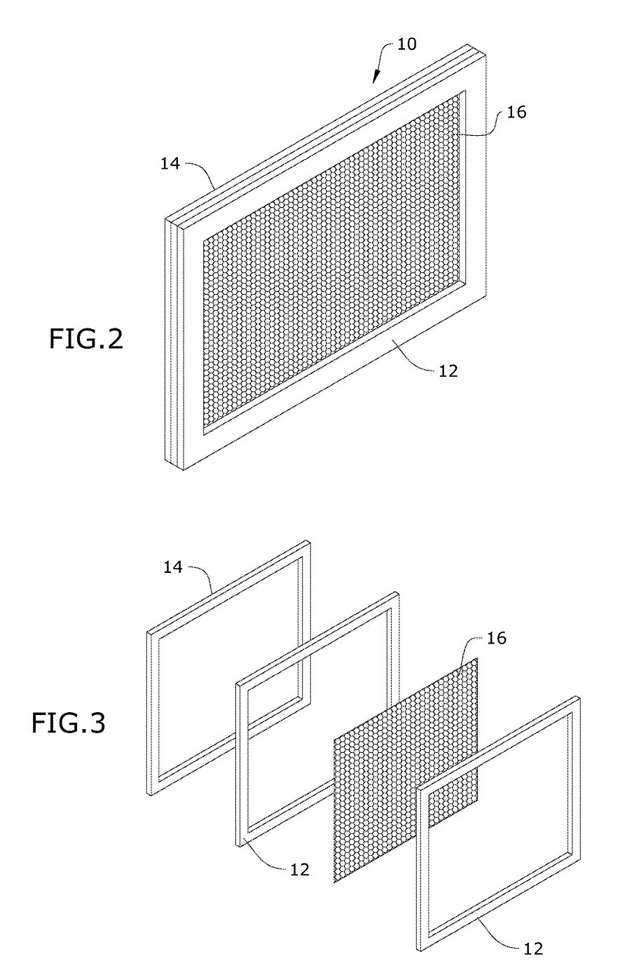

Referring now to FIGS. 1 through 4, the present invention may include an air filter system 100 adapted to prevent pet hair, dander and other pet particulate 22 from damaging electronic devices 30. The electronic devices 30 may include, but not be limited to, computers, laptops, all-in-one touchscreen devices, mobile devices and the like. The air filter system 100 may include at least one filter frame 10, each filter frame 10 having a filter medium 16 sandwiched along its periphery by a frame portion 12.

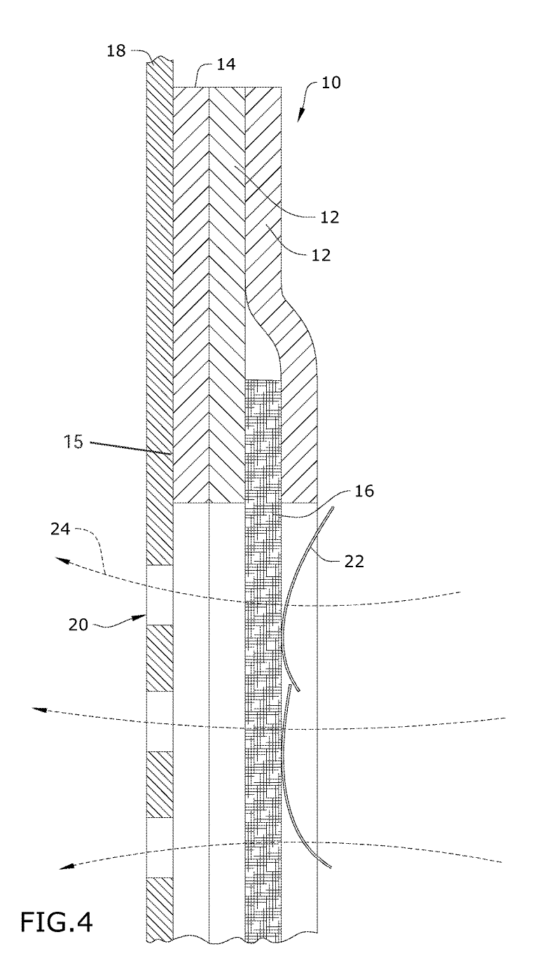

The filter medium 16 may be dimensioned and adapted to suitable filter pet and animal hair, dander and other pet particulate 22 from an air flow 24. For example, the filter medium 16 may include randomly arranged fibers adapted for the interception of pet particulate 22, as illustrated in FIG. 4. The filter medium 16 may be adapted to remove the pet particulate 22, including allergens, from the air flow 24. The filter medium 16 may include cell portions having advanced Photo Catalytic Oxidation (PCO) cells adapted to destroy biological contaminants and produce purifying plasma which reduces odors in all types of electronic devices 30.

The filter frame 10 may be dimensioned and adapted to circumscribe air vents 20 and other open portions of electronic devices 30 usually found in metallic casing 18 thereof, so that air flow 24 through the vents 20 must pass first through at least a portion of the air filter system 100. Accordingly, the shape and size of the filter frame(s) 10 can vary, depending on need. The filter frame 10 may provide a magnetic layer 14 for removably adhering to the metallic casing 18. The magnetic layer 14 may be affixed to the frame portion 12 by an adhesive or other form of low profile connection that does not protrude from the external face 15 of the magnetic layer 14.

The frame portions 12 may be made of cardboard or other pliable material so as to conform to the shape of the filter medium 16, thereby producing the thinnest possible profile, as illustrated in FIG. 4.

It should be understood, of course, that the foregoing relates to exemplary embodiments of the invention and that modifications may be made without departing from the spirit and scope of the present invention.

What is claimed is:

1. An air-filter system for preventing pet particulate from damaging electronic devices, compromising:
at least one sheet of filter medium;
a plurality of pairs of frame portions, wherein each pair of the plurality of pairs of frame portions sandwiches a periphery of each sheet of filter medium; and
a magnetic layer attached along one of each pair of frame portions.

2. The air-filter system of claim 1, wherein each magnetic layer is coextensive with said one of each pair of frame portions.

3. The air-filter system of claim 1, wherein the filter medium comprises Photo Catalytic Oxidation.

4. The air-filter system of claim 1, wherein the filter medium comprises randomly arranged fibers adapted for the interception of pet particulate.

5. The air-filter system of claim 1, wherein each pair of frame portions is pliable material so as to conform to said periphery.

6. An air-filter system for preventing pet particulate from damaging electronic devices, compromising:
at least one sheet of filter medium, wherein each filter medium comprises:
Photo Catalytic Oxidation; and
randomly arranged fibers adapted for the interception of pet particulate;
a plurality of pairs of frame portions, wherein each pair of the plurality of pairs of frame portions sandwiches a periphery of each sheet of filter medium; and
a magnetic layer attached along one of each pair of frame portions.

7. An air-filter system for preventing pet particulate from damaging electronic devices, compromising:
at least one sheet of filter medium, wherein each filter medium comprises:
Photo Catalytic Oxidation; and
randomly arranged fibers adapted for the interception of pet particulate;
a plurality of pairs of frame portions, wherein each pair of the plurality of pairs of frame portions sandwiches a periphery of each sheet of filter medium, wherein each pair of frame portions is pliable material so as to conform to said periphery; and
a magnetic layer attached along one of each pair of frame portions, wherein the magnetic layer is coextensive with said one of each pair of frame portions.
